(19) United States
(12) Patent Application Publication
(10) Pub. No.: US 2016/0096144 A1
(43) Pub. Date: Apr. 7, 2016

(54) METHOD OF MAKING SPIRAL WOUND FILTRATION MODULES WITH A CURABLE ADHESIVE COMPOSITION AND MODULES MADE THEREBY

(71) Applicant: H.B. FULLER COMPANY, ST PAUL, MN (US)

(72) Inventors: JOEL M. HARRIS, BLAINE, MN (US); CHRISTINE M. GRIESE, HUDSON, WI (US); DORIAN P. NELSON, ST. PAUL, MN (US); ALBERT M. GIORGINI, LINO LAKES, MN (US); BRIAN W. CARLSON, WOODBURY, MN (US); MICHAEL S. MOREN, SHOREVIEW, MN (US)

(21) Appl. No.: 14/872,572

(22) Filed: Oct. 1, 2015

Related U.S. Application Data
(60) Provisional application No. 62/058,468, filed on Oct. 1, 2014.

(51) Int. Cl. B01D 63/10

(52) U.S. Cl. CPC B01D 63/103

(57) ABSTRACT

A method of making spiral wound filtration modules with a multi-pack, solvent-free curable adhesive composition. The adhesive composition includes a multi-functional Michael donor, a multi-functional Michael acceptor, and a Michael reaction catalyst. The spiral wound filtration modules are also included.

This application claims the benefit of U.S. Provisional Application No. 62/058,468 filed Oct. 1, 2014, which is incorporated herein.

### FIELD OF THE INVENTION

The invention relates to a multi-pack, solvent-free adhesive composition that is obtainable by a Michael reaction of a Michael donor with a Michael acceptor in the presence of a suitable catalyst, its use in the Field of Filtration technology, specifically in making spiral wound filtration modules, and modules made thereby.

### BACKGROUND OF THE INVENTION

The term “ultrafiltration” is intended herein to encompass microfiltration, nanofiltration, ultrafiltration, reverse osmosis and gas separation, unless otherwise indicated.

A spiral wound filtration module include membrane sheets, permeate carriers and feed spacers wound around a permeate collection tube. Each membrane sheet has a membrane side and a backing side and is typically folded in half along its width to present two membrane leaves, integrally joined along the fold line to form a leaf packet. Membrane leaves in each leaf packet are oriented such that the membrane sides of the sheet face each other. If two or more leaf packets are used in a spiral wound filtration module, every two leaf packets are bonded together to form a membrane envelope by scaling the leaf side edges and the axial edges of the leaves distant from the permeate collection tube through an adhesive. The construction of the envelopes allows access to the permeate earners only from a radial direction through the membrane leaves.

Two-pan curable isocyanate-based adhesives have been used to manufacture spiral wound filtration modules.

### SUMMARY OF THE INVENTION

The present invention relates to a multi-pack, solvent-free, ambient temperature curable adhesive composition that has low toxicity (i.e., isocyanate-free) and has appropriate characteristics when cured, making it suitable for use in filtration applications and in particular in making spiral wound filtration modules.

In one aspect, the invention features a method of making a spiral wound filtration module. The module includes a permeate collection tube and one or more membrane leaf packet(s) wound about the collection tube; each membrane leaf packet has a first membrane leaf and a second membrane leaf and each membrane leaf has a membrane side and a backing side. The method includes preparing a mixture of a multi-pack, solvent-free adhesive composition by combining a multi-functional Michael donor, a multi-functional Michael acceptor, and a Michael reaction catalyst; applying the mixture of the adhesive composition onto at least a portion of the backing side of the first membrane leaf; winding the membrane leaf packet(s) around the collection tube; and allowing the adhesive composition to solidify and cure, thereby bonding the backing side of the second membrane leaf to the backing side of the first membrane leaf.

In some embodiments, the adhesive composition exhibits an initial viscosity from 1,000 centipoises (cP) to 100,000 cP at 25° C., and a Shore A hardness of no less than 60 after cured for 7 days at 25° C. and 50% relative humidity.

In one embodiment, the adhesive composition further includes up to 75% by weight of a filler.

In one embodiment, the catalyst has a conjugate acid that has a pKa of greater than 11.

In another aspect, the invention features a spiral wound filtration module that includes a permeate collection tube, and one or more membrane leaf packet(s). Each membrane leaf packet has a first membrane leaf and a second membrane leaf, and each of the first and second membrane leaves has a membrane side and a backing side. The one or more membrane leaf packet(s) wind about the collection tube such that the backing side of the second membrane leaf is bonded to the backing side of the first membrane leaf through an adhesive composition that includes a reaction product of a multi-functional Michael donor, a multi-functional Michael acceptor, and a Michael reaction catalyst.

The multi-pack, solvent-free adhesive composition of the invention exhibits, upon combination of the multi packs, appropriate initial viscosity and gel time to allow the penetration of the adhesive into the membrane sheets once the adhesive is applied to the sheets. The adhesive also exhibits good aqueous chemical resistance to strong acidic and basic solutions, good hydrolytic stability, and excellent flexibility. These characteristics are especially beneficial in the manufacture of spiral wound elements for food and dairy application, e.g., reverse osmosis filters, as well as other applications.

Further objects of the present invention will become clear from the further description hereinafter.

### BRIEF DESCRIPTION OF THE DRAWINGS

FIG. 1 is a fragmentary perspective view of a membrane sheet.

FIG. 2 is a perspective view of a membrane leaf packet

FIG. 3 is a perspective view (partially cut-away) of a partially assembled spiral wound module including a membrane leaf packet, as one embodiment of the invention.

FIG. 4 is a perspective view (partially cut-away) of a partially assembled spiral wound module including two membrane leaf packets that forms a membrane envelope, as another embodiment of the invention.

### GLOSSARY

In reference to the invention, these terms have the meanings set forth below:

“Michael reaction” refers to the addition reaction of a carbanion or nucleophile and an activated α,β-unsaturated carbonyl compound or group. A “Michael reaction” is a well-known reaction for the formation of carbon-carbon bonds and involves the 1,4-addition of a stabilized carbanion to an α,β-unsaturated carbonyl compound.

“Michael donor” refers to a compound with at least one Michael donor functional group, which is a functional group containing at least one Michael active hydrogen atom, which is a hydrogen atom attached to a carbon atom that is located between two electron-withdrawing groups such as C═O and/or C≡N, and/or NO₂ (nitro), and/or SO₂R (sulfone, R is an organic radical such as alkyl (linear, branched, or cyclic), aryl, heteroaryl, alkaryl, alkheteroaryl, derivatives and substituted versions thereof).

“Michael acceptor” refers to a compound with at least one Michael acceptor functional group with the structure (I):

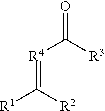

where R¹, R², R³ and R⁴ are, independently, hydrogen or organic radicals such as alkyl (linear, branched, or cyclic), aryl, alkaryl, derivatives and substituted versions thereof. R¹, R², R³ and R⁴ may or may not, independently, contain alkoxy, aryloxy, ether linkages, carboxyl groups, further carbonyl groups, thio analogs thereof, nitrogen-containing groups, or combinations thereof.

“Michael acceptor” also refers to a compound with at least one Michael acceptor functional group with the structure (II):

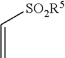

where R⁵ is an organic radical such as alkyl (linear, branched, or cyclic), aryl, heteroaryl, alkaryl, alkheteroaryl, derivatives and substituted versions thereof. R⁵ may or may not, independently, contain ether linkages, carboxyl groups, further carbonyl groups, sulfonyl groups, thio analogs thereof, nitrogen-containing groups, or combinations thereof.

“Gel time” refers to the time for an adhesive composition to achieve a gelled state at which the composition is no longer workable.

“Equivalent weight” is defined as the molecular weight of a compound divided by the number of reactivates or functionalities of the compound that are relevant to the Michael reaction.

“Ambient temperature” refers to a temperature of 25° C.+/−5° C.

“(Meth)acrylate” refers to acrylate or methacrylate; and “(meth)acrylic” refers to acrylic or methacrylic.

### DETAILED DESCRIPTION OF THE INVENTION

The present disclosure relates to a multi-pack, solvent-free curable adhesive composition and its use in making spiral wound filtration modules.

### Adhesive Composition

The adhesive composition includes a Michael donor, a Michael acceptor, and a Michael reaction catalyst, and is a multi-pack system. That is, the composition includes two or more parts as herein described. The ingredient(s) in each part is stored in a container (pack) separate from the others until the contents of all the containers are mixed together to form the mixture of the adhesive composition prior to the application. Upon applying and curing, a solid adhesive forms that adheres membrane sheets together. The phrase “multi-pack” is interchangeable herein with the phrase “multi-part”.

The adhesive composition is an isocyanate-free (NCO-free) and solvent-free curable composition based on acetoacetylated polymers obtainable through a Michael reaction between a Michael donor (e.g., acetoacetylated compound(s)) and a Michael acceptor (e.g., (meth)acrylate(s)) in the presence of a Michael reaction catalyst.

The adhesive composition is a liquid right after all the parts of the composition are mixed at an ambient temperature, e.g., 25° C.+/−5° C. Herein, a composition or a component is considered to be a liquid if it is liquid at an ambient temperature, e.g., 25° C.+/−5° C.

The adhesive composition is formulated to exhibit an adequate initial viscosity that allows the adhesive to be applied in a continuous bead form during the assembly of spiral wound filtration modules. In some embodiments, the adhesive composition is formulated to exhibit an initial viscosity of no greater than 100,000 centipoise (cP), or from 1,000 cP, or from 2,000 cP, or from 5,000 cP to no greater than 100,000 cP, or no greater than 50,000 cP, or no greater than 30,000 cP, or no greater than 25,000 cP at 25° C. Initial viscosity of the adhesive composition herein refers to the viscosity determined within 1 minute (min) to 5 min after all the parts of the composition are combined.

The time and complexity associated with fabricating a spiral wound filtration module increases with the number of membrane leaf packets used in the construction of the module. Since all the leaf packets in the module are wound together in the last step of rolling, it is important that the adhesive applied to a first leaf packet is not cured before the last leaf packet is inserted. Whether rolling manually or using automation, it is further desirable that the time for solidifying adhesive lines would be substantially longer than the time minimally required for constructing the module to avoid potential delays in the production line.

The adhesive composition of the invention is formulated to exhibit a gel time that is sufficient to allow the penetration of the adhesive into membrane sheets, and at the same time, adequate to allow the adhesive to cure at a rate that is applicable to the application (i.e., to allow subsequent processing steps to start faster without having to wait for long for the adhesive to be cured). In some embodiments, the adhesive exhibits a gel time of from 30 minutes, or from 35 minutes, or from 40 minutes to 60 minutes, or to 50 minutes from the combination of all the parts of the composition.

The adhesive composition is also formulated to exhibit high hardness. In some embodiments, the adhesive composition exhibits a Shore A hardness of no less than 60, or no less than 75, or no less than 80 after cured for 7 days at 25° C. and 50% relative humidity. The adhesive composition is also formulated to exhibit resistance to chemicals such as cleaning/sanitizing reagents e.g., caustic, bleach, acidic or peroxide reagents during harsh chemical cleaning cycles. In some embodiments, the adhesive composition exhibits less than 5% weight change after soaking in an acidic or a caustic solution for 28 days according to the herein described Chemical Resistance Test Method.

In addition, the adhesive composition has other advantages. For example, the adhesive composition is solvent-free, therefore, it docs not include any volatile organic compounds (VOCs). The adhesive composition also exhibits, upon cure, non-foaming behavior in the presence of moisture.

The adhesive composition has a workable viscosity and pot life and also cures quickly to develop a high hardness within 24 hours after the multi parts are combined Finally, the adhesive composition provides a strong adhesive bond that is resistant to humidity and chemicals.

In the adhesive compositions of the present invention, the relative proportion of multi-functional Michael acceptor(s) to multi-functional Michael donor(s) can be characterized by the reactive equivalent ratio, which is the ratio of the number of all the functional groups (e.g., in Structure I and/or Structure II) in the curable mixture to the number of Michael active hydrogen atoms in the mixture. The Michael donor component and the Michael acceptor component are blended together immediately prior to the application such that the equivalent ratio of the Michael acceptor functional acrylate groups to the Michael donor active hydrogens is from 0.3, or from 0.5 to 1.5, or to 1.

### Part A Multi-functional Michael Donor

The Part A of the adhesive composition includes at least one multi-functional Michael donor. In some embodiments, Part A includes more than one multi-functional Michael donors. In some embodiments, Part A is a liquid at ambient temperature.

Suitable Michael donors include those that are in a liquid form at ambient temperature. Suitable Michael donors also include those that are in a solid form at ambient temperature. When a Michael donor in solid form is included in Part A, it is preferably mixed with a Michael donor in liquid form such that the Part A is a liquid at ambient temperature. A “Michael donor” is a compound with at least one Michael donor functional group. Examples of Michael donor functional groups include malonate esters, acetoacetate esters, malonamidcs, acetoacetamides (in which Michael active hydrogens are attached to the carbon atom between two carbonyl groups), cyanoacetate esters and cyanoacetamides (in which Michael active hydrogens are attached to the carbon atom between the carbonyl group and the cyano group). A Michael donor may have one, two, three, or more separate Michael donor functional groups. Each Michael donor functional group may have one or two Michael active hydrogen atoms. A compound with two or more Michael active hydrogen atoms is known herein as a multi-functional Michael donor. The total number of Michael active hydrogen atoms on the donor molecule is known as the functionality of the Michael donor. A Michael donor is a compound composed of Michael donor functional group(s) and a skeleton (or core). As used herein, the “skeleton (or core) of Michael donor” is the portion of the donor molecule other than the Michael donor functional group(s).

Particularly preferred multi-functional Michael donors include acetoacetylated polyols. The polyols being acetoacetylated have at least one hydroxyl group, and preferably have two or more hydroxyl groups. The conversion of hydroxyl groups to acetoacetate groups should be between 80 mol % and 100 mol % and more preferably between 85 mol % and 100 mol %.

A method for making acetoacetylated polyols is well known in the art, such as Journal of Organic Chemistry 1991, 56, 1713-1718, “Transacetoacetylartion with tert-Butyl Acetoacetate Synthetic Applications”, in which the acetoacetylated polyol can be prepared by transesterification with an alkyl acetoacetate, e.g., tert-butyl acetoacetate.

In some embodiments, the multi-functional Michael donor is an acetoacetylated polyol that includes at least one acetoacetoxy functional group, and a skeleton of Michael donor selected from the group consisting of a polyether polyol, a polyester polyol, a polycarbonate polyol, a polybutadiene polyol, polyurethane polyol, urethane polyol, a glycol, a mono-hydric alcohol, a polyhydric alcohol, a natural oil polyol, and modifications thereof, and combinations thereof.

Examples of suitable polyhydric alcohols as skeletons for the multi-functional Michael donor (as well as for the below multi-functional Michael acceptor in Part B) include e.g., alkane diols, alkylene glycols, glycerols, sugars, pentaerythritols, polyhydric derivatives thereof, cyclohexane dimethanol, hexane diol, castor oil, castor wax, trimethylolpropane, ethylene glycol, propylene glycol, pentaerythritol, trimethylolethane, ditrimethylolpropane, dipentaerythritol, glycerin, dipropylene glycol, N,N,N′,N′-tetrakis(2-hydroxypropyl)ethylendiamine, neopentyl glycol, propanediol, butanediol, diethylene glycol, and the like.

Examples of more preferred polyols include trimethylolpropane (TMP), isosorbide, glycerol, neopentyl glycol (NPG), butyl ethyl propane diol (BEPD), tricyclodecane dimethanol, 1,4-cyclohexanedimethanol, hydroquinone bis(2-hydroxyethyl) ether, castor oil, castor wax, polybutadiene, polyester polyols, polyether polyols.

Examples of Michael donors include but are not limited to methyl acetoacetate, ethyl acetoacetate, n-propyl acetoacetate, isopropyl acetoacetate, n-butyl acetoacetate, t-butyl acetoacetate, ethylene glycol bisacetoacetate, 1,2 propanediol bisacetoacetate, 1,3 propanediol bisacetoacetate, 1,4 butanediol bisacetoacetate, neopentyl glycol bisacetoacetate, isosorbide bisacetoacetate, trimethylolpropane tris acetoacetate, glycerol tris acetoacetate, castor oil tris acetoacetate, castor wax tris acetoacetate, glucose tris acetoacetate, glucose tetraacetoacetate, sucrose acetoacetates, sorbitol tris acetoacetate, sorbitol tetra acetoacetate, acetoacetates of ethoxylated and propoxylated diols, triols and polyols such as ethoxylated neopentyl glycol bisacetoacetate, propoxylated glucose acetoacetates, propoxylated sorbitol acetoacetates, propoxylated sucrose acetoacetates, polyester acetoacetates in which the polyester is derived from at least one diacid and at least one diol, polyesteramide acetoacetates in which the polyesteramide is derived from at least one diacid and at least one diamine, 1,2 ethylene bisacetaroide, 1,4 butane bisacetamide, 1,6 hexane bisacetoacetamide, piperazine bisacetamide, acetamides of amine terminated polypropylene glycols, acetamides of polyesteramides acetoacetates in which the polyesteramide is derived from at least one diacid and at least one diamine, polyacrylates containing comonomers with acetoacetoxy functionality (such as derived from acetoacetoxyethyl methacrylate), and polyacrylates containing acetoacetoxy functionality and silylated comonomers (such as vinyl tximethoxysilane).

### Part B Multi-Functional Michael Acceptor

The Part B of the adhesive composition includes at least one multi-functional Michael acceptor. In some embodiments, Part B includes more than one multi-functional Michael acceptors. In some embodiments, Part B is a liquid at ambient temperature.

A “Michael acceptor” is a compound having at least one acceptor functional group as described above. A compound with two or more Michael acceptor functional groups is known herein as a multi-functional Michael acceptor. The number of functional groups on the acceptor molecule is the functionality of the Michael acceptor. As used herein, the “skeleton of the Michael acceptor” is the portion of the acceptor molecule other than the functional group(s).

The multi-functional Michael acceptor may have any of a wide variety of skeletons. Examples of the skeleton of the multi-functional Michael acceptor include a polyhydric alcohol (such as, those listed herein above in Part A Michael donor section); a polymer such as, a poly alkylene oxide, a polyurethane, a polyethylene vinyl acetate, a polyvinyl alcohol, a polybutadiene, a hydrogenated polybutadiene, an alkyd, an alkyd polyester, a (meth)acrylic polymer, a polyolefin, a polyester, a lialogenated polyolefin, a halogenated polyester, or combinations thereof.

Preferably, the multi-functional Michael acceptor is a multi-functional (meth)acrylate, which includes monomers, oligomers, polymers of the multi-functional_(meth)acrylate, and combinations thereof.

Examples of multi-functional (meth)acrylates suitable as the multi-functional Michael acceptor include 1,4-butanediol diacrylate, 1,6-hexanediol diacrylate, neopentyl glycol diacrylate, diethylene glycol diacrylate, triethylene glycol diacrylate, tetraethylene glycol diacrylate, polyethylene glycol diacrylate, dipropylene glycol diacrylate, tripropylene glycol diacrylate, cyclohexane dimethanol diacrylate, alkoxylated hexanediol diacrylate, alkoxylated cyclohexane dimethanol diacrylate, propoxylated neopentyl glycol diacrylate, trimethylolpropane triacrylate, ethoxylated trimethylolpropane triacrylate, propoxylated trimethylolpropane triacrylate, acrylated polyester oligomer, bisphenol A diacrylate, ethoxylated bisphenol A diacrylate, tris(2-hydroxyethyl) isocyanurate triacrylate, acrylated aliphatic urethane oligomer, acrylated aromatic urethane oligomer, and the like, and combinations thereof.

Other examples of suitable multi-functional (meth)acrylates include tetraethylene glycol dimethacrylate, trimethylolpropane trimethacrylate, ditrimethylolpropane-tetraacrylate, ditrimethylolpropane-tetramethacrylate, pentaerythritol tetraacrylate, pentaerythritol tetramethacrylate and the like. In accordance with the present invention, a adhesive composition can additionally contain mono α,β-unsaturated compounds such as a monoacrylate.

Further examples of suitable multi-functional Michael acceptors include multi-functional (meth)acrylates in which the skeleton is polymeric. The (meth)acrylate groups may be attached to the polymeric skeleton in a wide variety of ways. For example, a (meth)acrylate ester monomer may be attached to a polymerizable functional group through the ester linkage, and that polymerizable functional group may be polymerized with other monomers in a way that leaves the double bond of the (meth)acrylate group intact. For another example, a polymer may be made with functional groups (such as, a polyester with residual hydroxyls), which may be reacted with a (meth)acrylate ester (for example, by transesterification) to yield a polymer with pendant (meth)acrylate groups. For yet another example, a homopolymer or copolymer may be made that includes a multi-functional (meth)acrylate monomer (such as trimethylolpropane triacrylate) in such a way that not all the acrylate groups react.

Mixtures or combinations of suitable multi-functional Michael acceptors are also suitable.

Examples of suitable commercially available multi-functional Michael acceptors include multi-functional polyester acrylates under the trade designations CN292, CN2283, CN2207, and CN2203; polyethylene glycol diacrylate under the trade designation SR344; ethoxylated bisphenol A diacrylates under the trade designations SR349, SR601 and SR602; tricyclodecane dimethanol diacrylate under the trade designation SR833 S; hexafunctional aromatic urethane acrylate under the trade designation CN 975; trifunctional urethane acrylate under the trade designation CN 929; and aliphatic polyester based urethane hexa-acrylate under the trade designation CN 968, all of which are available from Sartomer USA, LLC (Exton, Pa.).

It is believed that reacting a Michael donor having functionality of 2 with a Michael acceptor having a functionality of 2 will lead to linear molecular structures. To create molecular structures that are branched and/or crosslinked, one would use at least one ingredient having a functionality of 3 or greater. Therefore, it is preferred that either the multi-functional Michael donor or the multi-functional Michael acceptor or both have a functionality of 3 or greater.

In the practice of the present invention, the skeleton of the multi-functional Michael acceptor may be the same or different from the skeleton of the multi-functional Michael donor.

### Michael Reaction Catalyst

The adhesive composition also includes a Michael reaction catalyst. A Michael reaction catalyst is a catalyst that is capable of initiating a Michael reaction. The catalyst may be included in Part A, or Part B, or combination thereof.

Alternatively, the catalyst may be provided to the adhesive composition as a separate component, such as a Part C.

The catalyst is present in the adhesive composition in an amount from 0.1%, or from 0.5% to 10%, or to 1.5%, based on the mole of Michael active hydrogen atoms.

Useful Michael reaction catalysts include both strong base catalysts, of which the conjugated acid has a pKa of greater than 11; and weak base catalysts, of which the conjugated acid has a pKa of from 4 to 11. Examples of suitable strong base catalysts include guanidines, omidines, and combinations thereof, such as 1,1,3,3-tetra methyl guanidine (TMG), 1,8-Diazabicyclo(5.4.0)undec-7-ene (DBU), and 1,5-Diazabicyclo(4.3.0)non-5-ene (DBN). Examples of suitable weak base catalysts include tertiary amines, alkali metal carbonates, alkali metal bicarbonates, alkali metal hydrogen phosphates, phosphines, alkali metal salts of carboxylic acids including but not limited to triethylamine, sodium carbonate, potassium carbonate, sodium bicarbonate, potassium bicarbonate, potassium hydrogen phosphate (mono-basic and di-basic), and potassium acetate. Examples of other Michael reaction catalysts include tripbenyl phosphine, diethyl phosphine, and tributyl phosphine.

In some embodiments, the Michael reaction catalyst is a strong base catalyst, of which the conjugated acid preferably has a pKₐ of greater than 11, or from 12 to 14. Preferably the bases are organic. Examples of such bases include amindines and guanidines. More preferred catalysts include 1,1,3,3-tetramethylguanidine (TMG), 1,8-diazabicyclo-[5.4.0]undes-7-ene (DBU), and 1,5-diazabicyclo[4,3,0]non-5-ene (DBN).

### Part D Combination of Multi-Functional Michael Donor and Multi-functional Michael Acceptor

In some embodiments, the multi-functional Michael donor(s) and acceptors) can be placed together in one pack, and the Michael reaction catalyst can be placed in another pack. The two packs are mixed together immediately before the application.

Therefore, in some embodiments, the adhesive composition includes a Part D and a Part C. Part D includes a combination of any one of the herein described Part A and any one of the herein described Part B. Part C includes any one of the herein described Michael reaction catalysts. The Part D and Part C are mixed together immediately before the application.

In some embodiments, Part D includes a dual functional compound that includes a Michael donor functionality and a Michael acceptor functionality. The dual functional compound can be a dual functional monomer, a dual functional oligomer, a dual functional polymer, and combinations thereof.

### Other Additives

In some embodiments, the adhesive composition may include a filler in an amount of up to 75% by weight, or from 0.5% by weight, or from 1% by weight to 75% by weight, or to 50% by weight, or to 30% by weight, or to 20% by weight, or to 10% by weight, based on the weight of the composition. Examples of suitable fillers include silica, calcium carbonate, clay, wollastonite, and combinations thereof. The filler may be included in any part(s) of the multi-pack adhesive composition.

The adhesive composition may also include other optional additives in any part(s) of the multi-pack adhesive composition. Optional additives include, e.g., antioxidants, plasticizers, wax, thixotropes, adhesion promoters, catalyst deactivators, colorants (e.g., pigments and dyes), surfactants, defoamers, diluents (including reactive diluents), tackifiers, reinforcing fillers, tougheners, impact modifiers, stabilizers e.g., triethyl phosphate, and combinations thereof.

### Method of Making and Using

The adhesive composition of the invention is a multi-pack composition. That is, the composition includes two or more parts, the ingredient(s) in each part is stored in a container (pack) separate from the others until the contents of all the containers are mixed together to form the mixture of the adhesive composition prior to the application. Each individual pack of the multi-pack composition is storage stable. Mixing of all the packs together may be performed at ambient temperature or at elevated temperature.

The adhesive composition of the invention is useful for bonding membrane sheets together to make spiral wound filtration modules. A spiral wound filtration module is a common configuration for reverse osmosis and nanofiltration membranes.

In one embodiment of assembling a spiral wound filtration module, one or more membrane leaf packet(s) and feed spacer sheets are wrapped about a central permeate collection tube. Each leaf packet include two generally rectangular membrane sheets surrounding a permeate carrier sheet. This “sandwich” structure is held together by a bonding adhesive along three edges of each membrane sheet: the back edge farthest from the permeate tube, and the two side edges that will become the feed (inlet) and concentrate (outlet) ends of the module. The bonding adhesive at the two side edges additionally affix and seal membrane sheets to the permeate collection tube at each end of the module. The fourth edge (i.e., the fold edge) of the membrane sheets is open and abuts the permeate collection tube so that the permeate carrier sheet is in fluid contact with small holes on the permeate collection tube and the fluid is passing through the permeate collection tube.

Other features and advantages of the invention will be apparent from the following description of the preferred embodiments, the drawings, and from the claims.

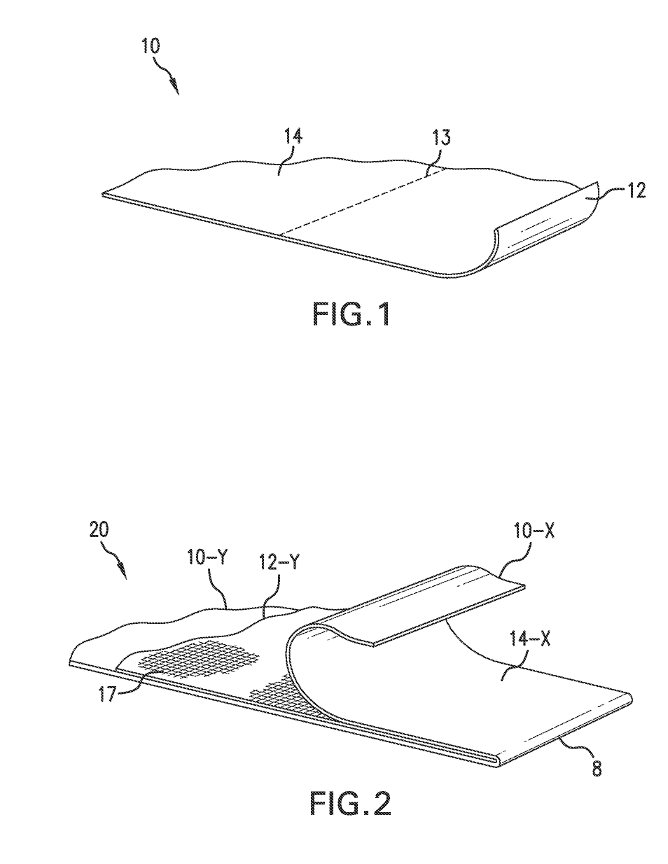

Turning to FIG. 1, a membrane sheet 10 includes a membrane side 12, a backing side 14 and a dotted fold line 13 across the width of membrane sheet 10. The membrane side 12 is composed of a membrane material (examples of membrane material include e.g., polysulfone and polyethersulfone) and backing side 14 is composed of a backing material (an example of the backing material is polyester), both membrane material and backing material are integrally laminated by techniques well known in the art to form membrane sheet 10. Acceptable membrane materials and backing materials are also well known in the art.

Turning to FIG. 2, a membrane leaf packet 20 is formed from membrane sheet 10 by dividing and folding membrane sheet 10 along the fold line 13 to present a first membrane leaf 10-X and a second membrane leaf 10-Y such that the first and the second leaves have substantially the same size. Herein, the term “membrane sheet” refers to the combination of leaves 10-X and 10-Y in a leaf packet. The line dividing the first leaf 10-X from the second leaf 10-Y refers to as “fold line”, the areas of the first and second leaves 10-X and 10-Y adjacent the fold line refer to as “fold area”, and the edge 8 along the fold line 13 of the first and the second leaves (10-X, 10-Y) refers to as “fold edge”. The first and second membrane leaves 10-X and 10-Y of membrane sheet 10 are positioned relative to each other such that the membrane side 12-X (not shown) of the first leaf 10-X and the membrane side 12-Y of the second leaf 10-Y face one another. In this preferred embodiment, feed spacer 17 is positioned between the leaves 10-X and 10-Y within the leaf packet 20. Feed spacer 17 generally has a relatively large mesh size to allow the fluid to be filtered to travel between membrane sides 12-X and 12-Y of leaves 10-X and 10-Y of membrane sheet 10. Although feed spacer 17 is utilized in most spiral wound filtration modules, it is possible and known in the art to construct a module without feed spacer 17. The materials and construction of feed spacer 17 are well known in the art.

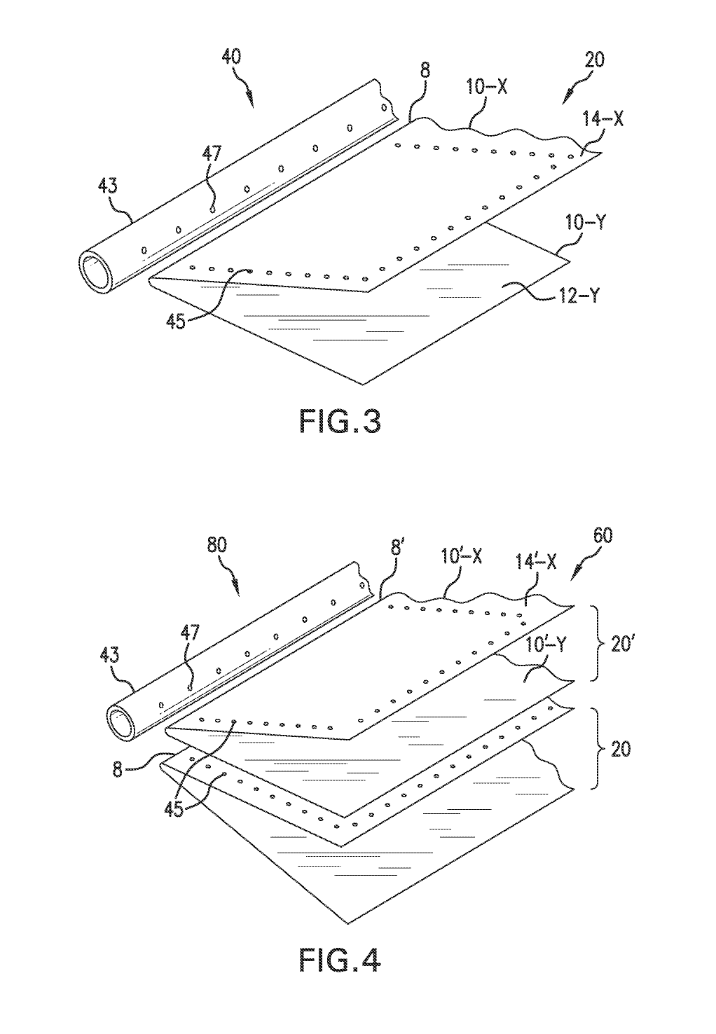

FIG. 3 illustrates an embodiment of a partially assembled filtration module 40 including a collection tube 43 and a leaf packet 20 as shown in FIG. 2. An adhesive composition 45 e.g., any of the aforementioned multi-pack, sol vent-tree curable adhesive composition is applied in a continuous bead form on the backing side 14-X along the three edges of the first membrane leaf 10-X. Adhesive 45 may be dispensed at ambient temperature e.g., 25° C. using dispensing method known in the art. The technique of applying a multi-pack, solvent-free curable adhesive composition to spiral wound membrane leaves is well know and understood in the art. For example, the adhesive can be mixed via a mix tube and dispensed using a mix equipment known in the art to a preferred bead size of from about ⅛ to about ¾ inch, more preferably from about ⅛ to about ¼ inch. The adhesive 45 is flexible, has a hardness within the Shore A range after curing, and is resistant to chemicals, including chemicals selected from the group consisting of chlorine, acidic cleaning solutions and caustic cleaning solutions. Further, the adhesive has good initial and long-term adhesion to membrane sheet 10 and a short cure time.

Upon winding (or rolling), the leaf packet 20 concentrically about the collection tube 43, the backing side 14-Y (not shown) of the second membrane leaf 10-Y is bonded to the backing side 14-X of the first membrane leaf 10-X with the adhesive 45 along the three edges.

FIG. 4 illustrates a partially assembled filtration module 80 including a collection tube 43 and two leaf packets partially assembled from a first leaf packet 20 (as shown in FIG. 3) and a second leaf packet 20′, which has the same structure as the first leaf packet 20. The first leaf packet 20 includes a first leaf 10-X and a second leaf 10-Y (as shown in FIG. 3). The second leaf packet 20′ includes a first leaf 10′-X and a second leaf 10′-Y. The second leaf packet (20′) is placed on top of the first leaf packet (20) such that the backing side (not shown) of the second leaf (10′-Y) of the second leaf packet (20′) faces the backing side (14-X) of the first leaf 10-X of the first packet (20). All the edges of the first and second membrane leaf packets (20,20′) are aligned such that the fold edge 8 of the first leaf packet 20 is aligned and parallel with the fold edge 8′ of the second leaf packet 20′. The facing membrane leave (10-X, 10′-Y) are adhered together with adhesive 45 along three peripherally edges, leaving fold edges (8, 8′) of the leaf packets (20,20′) unadhered. The fold edges (8, 8′) are in fluid contact with the permeate collection tube 43 via openings 47.

An adhesive composition 45 e.g., any of the aforementioned multi-pack, solvent-free curable adhesive composition is applied in a continuous bead form on the backing side 14-X (as shown in FIG. 3) as well as on the backing side 14′-X along three edges of the first membrane leaf 10′-X of the second leaf packet 20′. Upon winding the two leaf packets around the collection tube 43, the backing side 14-Y (not shown) of the second membrane leaf 10-Y (as shown in FIG. 3) of the first membrane leaf packet 20 is bonded to the backing side 14′-X of the first membrane leaf 10′-X of the second leaf packet 20′ with the adhesive 45 along the three edges to form a finished filtration module.

Alternatively, the process herein described may be repeated a number of times so that it is possible to make a multi-layered leaf packets that consist of more than two bonded leaf packets. For example, a third leaf packet could be bonded to the second leaf packet 20′ by repeating the aforementioned process, so that a plurality of leaf packets are assembled together prior to the winding step to form the module.

The adhesive 45 allows relative movement of various membrane sheets during the winding process. That is, the cure rate or period of gel time is longer than that required to assemble and wind one or more membrane leaf packet(s) about the permeate collection tube to produce a filtration module.

The invention encompasses various spiral wound filtration modules along with methods for making and using the same through any of the aforementioned adhesives of the invention. The configuration of the spiral wound filtration module is not particularly limited. Examples of other spiral wound filtration modules in which the adhesive composition of the present invention is particularly useful include those constructions described in, e.g., U.S. Pat. No. 4,842,736, U.S. Pat. No. 5,096,584, U.S. Pat. No. 5,114,582, U.S. Pat. No. 5,147,541, U.S. Pat. No. 5,681,467, U.S. Pat. No. 6,881,336, U.S. Pat. No. 7,303,675, U.S. Pat. No. 7,335,301, US2008/0295951, WO2012/058038, and EP 1637214, which are incorporated herein by reference in their entirety.

Any suitable method of bonding a membrane sheet can be used to make the membrane leaf packet and/or membrane envelope for spiral wound filtration modules. Useful application temperatures range from about 20° C. to about 50° C. Lower temperatures are preferred during the application process in order to extend the working life of the adhesive composition.

The disclosed adhesive composition can be processed in an automated process.

The present disclosure may be further understood with reference to the following examples. These examples are intended to be representative of specific embodiments of the disclosure and are not intended to be limiting to the scope of the disclosure.

All parts, ratios, percents, and amounts stated herein and in the examples are by weight unless otherwise specified.

### EXAMPLES

### Test Methods

### Viscosity

The viscosity is determined using a Brookfield DV-II+ Pro viscometer (from Brookfield Engineering, USA) using Spindle #27 at 2 rpm (revolutions per minute) and 12 grams of a sample material at 25° C.±5+ C., or 30° C.+5° C., and 50% relative humidity.

### Glass Transition Temperature (T_{g})

The glass transition temperature (T_{g}) of a cured composition is determined according to ASTM D-3418-83 entitled “Standard Test Method for Transition Temperatures of Polymers by Differential Scanning Calorimetry (DSC)” with conditioning a sample at 140° C. for two minutes, quench cooling the sample to −60° C. and then heating the sample to 140° C. at a rate of 20° C. per minute. The reported T_{g} is the temperature at which onset of the phase change occurs.

### Shore A Hardness

Shore A hardness of a cured composition is determined using a hand held hardness meter from Paul N. Gardner Company, Inc. USA, and Shore A scale at 25° C.±5° C. and 50% relative humidity. The cured composition is cured for 7 days at 25° C.±5° C. and 50% relative humidity.

### Gel Time

The gel time of a multi-pack, solvent-free adhesive composition is determined using a Gardco Standard Gel Timer (from Paul N. Gardner Company, Inc., USA) at 25° C.±5° C. and 50% relative humidity. A 110 gram mixture of Part A (Michael donor and Michael reaction catalyst) and Part B (Michael acceptor) is mixed and deposited in an aluminum dish in the timer unit, a wire stirrer is inserted, the display is set to zero and the timer is turned on. The gel timer stirs until gel occurs (the viscosity of the mixture increases to a point where the drag exceeds the torque of the motor and the motor stops), stopping the timer and stirrer. The time on the timer is recorded as the gel time in minutes.

### Chemical Resistance Test Method

Chemical resistance is determined as follows:

Test specimens are prepared by making 10 gram pucks of a multi-pack, solvent-free adhesive composition. The pucks of the composition are cured at 25° C.+5+ C. and 50% relative humidity for 7 days. The cured specimens are weighed and the initial weight is recorded. The cured specimens are soaked in either acidic or basic conditions for a duration of 28 days. For acidic conditions three cured puck specimens are soaked in a pH 1 solution (0.1M HC1) at 25° C.±5° C. and 50% relative humidity for 28 days. For basic conditions the three cured puck specimens are soaked in a pH 12 solution (NaOH_{aq}) at 40° C.±5° C. and 50% relative humidity. After 7, 14,21, and 28 days the pucks are removed from the test solution, rinsed off with deiomzed water at ambient temperature, dried for one hour, weight recorded, and re-soaked in the appropriate fresh solution. Chemical resistance is reported as the percent % weight change (weight loss or weight gain) of the cured puck specimens.

### Bubble Formation Test Method

The formation of bubbles of a multi-pack, solvent-free adhesive composition is determined by mixing a 100 g mixture of part A (donor and catalyst) and part B (acceptor) and allowing the mixture to cure at 25° C.±5° C. and 50% relative humidity for 7 days. After cure the composition is visually inspected for the formation of bubbles. The absence of bubbles within the cured composition is a pass. The appearance of bubbles within the cured composition constitutes a fail.

### Michael Donor

The following Michael donors were used for making the adhesive composition to be tested in the Examples:

### Donor 1 (D-1) (Acetoacetoxy Trimethylolpropane (AATMP)

Donor 1 was prepared by adding trimethylolpropane and tert-butyl acetoacetate (TBAA) to a reaction kettle equipped with a stirrer and a distillation column connected to a vacuum line. Amounts of the polyol and TBAA were used to provide a desired conversion degree of the polyol with 100 mol % conversion using TBAA in a molar excess of ⅓. The reaction was carried out at 120° C. for 2 hours and tert-butanol by-product was collected by distillation. The reaction was continued at this temperature until no more tert-butanol was collected. The reaction was cooled to ambient temperature, vacuum was applied and the reaction was heated to 120° C. over 1 hour to collect any residual tert-butanol and tert-butylacetoacetate. The reaction was heated at 125° C. for 3-4 hours or until no further tert-butanol or tert-butylacetoacetate was collected. The acctoacetylated polyol was cooled and stored for use.

Donor 2 (D-2) (a Mixture of 75% by Weight of D-1 and 25% by Weight of di-acetoacetate of VORANOL 220-056N)

Donor 2 was prepared by mixing 75% by weight of D-1 and 25% by weight of di-acetoacetate of VORANOL 220-056N. Di-acetoacetate of VORANOL 220-056N was prepared according to the procedure as that in D-1, except that VORANOL 220-056N (polyether polyol, commercially available from Dow Chemical) was used instead of trimethylolpropane.

### Donor 3 (D-3)

Donor 3 (D-3) was prepared according to the procedure as that in D-1, except that K-FLEX® UD-320-100 (a polyurethane diol commercially available from King Industries (Norwalk, Conn.)) was used instead of trimethylolpropane.

### Michael Acceptor

The following Michael acceptors were used for making the adhesive composition to be tested in the Examples:
Acceptor 1 (A-1): multi-functional polyester acrylate oligomer (CN2207 available from Sartomer USA, LLC).
Acceptor 2 (A-2): multi-functional polyester acrylate oligomer (CN292 available from Sartomer USA, LLC).
Acceptor 3 (A-3): ethoxylated (4) bisphenol A diacrylate (SR601 available from Sartomer USA, LLC).
Acceptor 4 (A-4): 20% CN 292,60% SR833 S (tricyclodecane dimethanol diacrylate, available from Sartomer USA, LLC), and 20% CN 929 (trifunctional urethane acrylate available from Sartomer USA, LLC).
Acceptor 5 (A-5): 20% CN 292,75% SR833 S, and 5% CN 929.
Acceptor 6 (A-6): 25% CN 292, 50% SR833 S, and 25% CN 929.

### Michael Reaction Catalyst

The following Michael reaction catalyst was used for making the adhesive composition to be tested in the Examples:

1,8-diazabicyclo[5.4.0.]undec-7-ene (DBU, available from Air Products).

### Examples 1-10 and Comparative Example 1

Each adhesive composition of Examples 1-10 and Comparative Example 1 was prepared by combining Part A and Part B according to Table 1 at ambient temperature prior to the testing, and then was tested according to the herein described various test methods. The results are listed in Tables 1 and 2.

TABLE 1

| | | | Mix Ratio by | |
|---|---|---|---|---|
| | Part A | Part B | Weight (A:B) | Shore A (±2) |
| Comp. Ex. 1 | *UR3501A | *UR3501B | 1:0.625 | 90 |
| Ex. 1 | D-1, | A-1 | 1:2.5 | 78 |
| | 1% DBU | | | |
| Ex. 2 | D-1, | A-1 | 1:5 | 95 |
| | 1% DBU | | | |
| Ex. 3 | D-1 | A-2 | 1:3.15 | 94 |
| | 1.5% DBU | | | |
| Ex. 4 | D-1 | A2 | 1:3.05 | 96 |
| | 1.5% DBU | | | |
| Ex. 5 | D-1 | A-3 | 1:2.15 | 95 |
| | 1.5% DBU | | | |
| Ex. 6 | D-1 | A-4 | 1:3.3 | 100 |
| | 1.2% DBU | | | |
| Ex. 7 | D3 | A-4 | 1:1.8 | 100 |
| | 1.2% DBU | | | |
| Ex. 8 | D-1 | A-5 | 1:2.5 | 100 |
| | 1.2% DBU | | | |
| Ex. 9 | D-1 | A-6 | 1:3.6 | 100 |
| | 1.2% DBU | | | |
| Ex. 10 | D-1 | A-4 | 1:1.75 | 95 |
| | 1.2% DBU | | | |

*Two-part polyurethane adhesive commercially available from H. B. Fuller (St. Paul, MN).

TABLE 2

| | | | Chemical | | |
|---|---|---|---|---|---|
| | | Gel Time | Resistance* | | |
| | Initial | (min at | pH = | pH = | |
| | Viscosity | 25° C.) | 1 (at | 12 (at | Bubble |
| | (cP at 25° C.) | (±5 min) | 25° C.) | 40° C.) | Formation |
| Comp. Ex. 1 | 22,000 | 50 | pass | pass | Yes |
| Ex. 1 | 9,300 | 50 | pass | pass | No |
| Ex. 2 | 22,000 | 35 (5 mm | NT** | NT | No |
| | | at 50° C.) | | | |
| Ex. 3 | 1,500 | 32 | pass | pass | No |
| Ex. 4 | 2,000 | NT | NT | NT | No |
| Ex. 5 | 1,200 | 22 | NI' | NT | No |
| Ex. 6 | 1150 | 41 | pass | pass | no |
| Ex. 7 | 2500 | 60 | pass | pass | no |
| Ex. 8 | 1100 | 44 | pass | pass | no |
| Ex. 9 | 1900 | 42 | pass | pass | no |
| Ex. 10 | 1050 | 65 | pass | pass | no |

*Pass: less than 5% weight gain or loss.
**NT: not tested.

The above specification, examples and data provide a complete description of the disclosure. Since many embodiments can be made without departing from the spirit and scope of the disclosure, the invention resides in the claims hereinafter appended.

We claim:

1. A method of making a spiral wound filtration module, the spiral wound filtration module comprising a permeate collection tube and one or more membrane leaf packet(s) wound about the collection lube, each membrane leaf packet having a first membrane leaf and a second membrane leaf and each membrane leaf having a membrane side and a backing side, the method comprising
preparing a mixture of a multi-pack, solvent-free curable adhesive composition by combining a multi-functional Michael donor, a multi-functional Michael acceptor, and a Michael reaction catalyst,
applying the mixture of the curable adhesive composition onto at least a portion of the backing side of the first membrane leaf,
winding the membrane leaf packet(s) around the collection tube, and
allowing the curable adhesive composition to solidify and cure, thereby bonding the backing side of the second membrane leaf to the backing side of the first membrane leaf.

2. The method of claim 1, wherein the curable adhesive composition exhibits an initial viscosity of from 1,000 centipoise (cP) to 100,000 cP at 25° C.

3. The method of claim 1, wherein the first membrane leaf has three peripheral edges and one fold edge, and the adhesive composition is applied along the three peripheral edges of the backing side of the first membrane leaf.

4. The method of claim 1, wherein the adhesive composition further comprises from 0% by weight to 75% by weight a filler, based on the weight of the curable adhesive composition.

5. The method of claim 1, wherein the multi-functional Michael donor comprises an acetoacetylated polyol that has at least one acetoacetoxy functional group, and a skeleton selected from the group consisting of a polyether polyol, a polyester polyol, a polycarbonate polyol, a polybutadiene polyol, polyurethane polyol, urethane polyol, a glycol, a mono-hydric alcohol, a polyhydric alcohol a natural oil polyol, and modifications thereof, one combinations thereof.

6. The method of claim 1, wherein the multi-functional Michael acceptor is selected from the group consisting of monomers, oligomers, and polymers of multi-functional (meth)acrylate, and combinations thereof.

7. The method of claim 1, wherein the catalyst is a strong base catalyst having a conjugate acid that has a pKa of greater than 11.

8. The method of claim 1, wherein the curable adhesive composition exhibits a Shore A hardness of at least 60 after cured for 7 days at 25° C. and 50% relative humidity.

9. The method of claim 1, wherein the curable adhesive composition exhibits, upon cure, non-foaming behavior in the presence of moisture.

10. A spiral wound filtration module, comprising
a permeate collection tube, and
one or more membrane leaf packet(s), each membrane leaf packet having a first membrane leaf and a second membrane leaf, each membrane leaf having a membrane side and a backing side, the one or more membrane leaf packet(s) being wound about the collection tube such that the backing side of the second membrane leaf is bonded to the backing side of the first membrane leaf through an adhesive composition that comprises a reaction product of
a multi-functional Michael donor,
a multi-functional Michael acceptor, and
a Michael reaction catalyst.

11. The spiral wound filtration module of claim 10, wherein each membrane leaf has three peripheral edges and one fold edge, and the adhesive composition is applied along the three peripheral edges of the backing side of the first membrane leaf.

12. The spiral wound filtration module of claim 10, wherein the adhesive composition exhibits a Shore A hardness of at least 60 after cured for 7 days at 25° C. and 50% relative humidity.

13. The spiral wound filtration module of claim 10, wherein the adhesive composition further comprises from 0% by weight to 75% by weight of a filler.

14. The spiral wound filtration module of claim 10, wherein the adhesive composition exhibits, upon cure, non-foaming behavior in the presence of moisture.
